(19) United States
(12) Patent Application Publication
(10) Pub. No.: US 2025/0378614 A1
(43) Pub. Date: Dec. 11, 2025

(54) METHODS AND SYSTEM FOR GENERATING AN IMAGE OF A HUMAN

(71) Applicants: Lemon Inc., Grand Cayman (KY); Beijing Zitiao Network Technology Co., Ltd., Haidian District, Beijing (CN)

(72) Inventors: Jiashi FENG, Singapore (SG); Jianfeng ZHANG, Singapore (SG); Zihang JIANG, Beijing (CN)

(21) Appl. No.: 18/876,948

(22) PCT Filed: Jun. 29, 2023
(86) PCT No.: PCT/CN2023/104240

§ 371 Date: Dec. 19, 2024

(30) Foreign Application Priority Data
Jul. 8, 2022 (SG) 10202250421B

(51) Int. Cl. G06T 13/40; G06N 3/0455; G06N 3/08; G06T 7/70; G06T 15/20

(52) U.S. Cl. CPC G06T 13/40; G06N 3/0455; G06N 3/08; G06T 7/70; G06T 15/20; G06T 2207/10024; G06T 2207/20081; G06T 2207/30196

(57) ABSTRACT

Camera parameters describing a view angle, and pose parameters describing a shape and a pose of a parametric human body model, are processed to generate geometry information (which characterizes a 3D geometry of the human), and the appearance information (which characterizes a RGB appearance of the human). These in turn are processed to generate the image of the human. In the image, the human is depicted viewed from the view angle and with the body of the human having the shape and the pose described by the pose parameters.

### CROSS-REFERENCE TO RELATED APPLICATIONS

This application claims priority to Singapore Application No. 10202250421B, entitled Methods and system for generating an image of a human, filed on Jul. 8, 2022, the entire contents of that application being incorporated herein by reference in its entirety.

### TECHNICAL FIELD

The present application relates to method and systems for the generation of images of humans using a neural network.

### BACKGROUND

Virtual humans (avatars) with full control over their pose and appearance are used in applications such as immersive photography visualization, virtual try-on, VR/AR and creative image editing. Known solutions to create images of virtual humans rely on classical graphics modeling and rendering techniques. Although offering high-quality, they typically require pre-captured templates, multi-camera systems, controlled studios, and long-term works of artists.

Neural networks offer the advantage of image synthesis at low cost. However, known methods which adopt neural networks for 3D-aware image synthesis are either limited to rigid object modeling or learn articulated human representations for a single subject. The former limits quality and controllability of more challenging human generation while the latter is not generative and thus does not synthesize novel identities and appearances.

### SUMMARY

The present invention aims to provide new and useful methods for generating images of a human, and particularly ones in which the body of the human is shown in a desired pose. That is, the image includes at least part of the human's torso and at least a portion of one of more (typically all) of the human's limbs.

In broad terms, the present invention proposes a generator neural network suitable to synthesize an image of a human where the shape and pose of the human depicted in the image are controlled by external inputs received by the generator neural network. One way of implementing this is for the generator neural network to generate an intermediate 3D representation of the human in a predefined pose. To generate a feature image of the human in the desired pose, the intermediate 3D representation is sampled at a plurality of spatial points to obtain feature data, and the obtained feature data is assigned to spatial points in the feature image according to a mapping that takes into account the desired pose and a predetermined pose (that is, a single fixed pose which is used during training of the network; for example, the predetermined pose may be a pose in which all limbs of the person are extended straight out from the torso of the person). The final image is generated from the feature image by a decoder.

In one aspect, the invention suggests that camera parameters describing a view angle, and pose parameters describing a shape and a pose of a parametric human body model, are processed to generate geometry information (which characterizes a 3D geometry of the human), and the appearance information (which characterizes a RGB appearance of the human). These in turn are processed to generate the image of the human. In the image, the human is depicted viewed from the view angle and with the body of the human having the shape and the pose described by the pose parameters.

In implementations, the camera parameters are used to generate a representation of a first 3D space comprising a human in the predetermined pose. This representation is sampled at one or more index locations (typically multiple index locations) obtained based on the camera parameter and the pose parameters. The representation is conveniently obtained based on a latent vector of, for example, random numbers. In one computationally efficient form, the representation may be a tri-plane representation, based on 3 feature planes.

The index locations may be created by choosing spatial positions (“first spatial positions”) in a first image of the parametric human body model arranged in the pose described by the pose parameters, and converting the first spatial positions into corresponding second spatial positions in a second image which shows the parametric body model in the predetermined pose. A neural network for making this mapping, based on the pose parameters, can be readily obtained using known techniques.

The index positions may then be obtained based on the second spatial positions. Optionally, the second spatial positions may be deformed by a deformation network model to generate the index locations.

The appearance information for each index location may be processed (e.g. by another adaptive unit, such as a multi-layer perceptron) to generate the appearance information.

In principle, the geometry information could be obtained in the same way, using another adaptive unit. However, more preferably, the geometry information is obtained by generating 3D mesh data of the parametric human model arranged in the predefined pose and with the shape described by the pose parameters; sampling the 3D mesh data of the parametric human model at the index location to obtain a first distance value; using the first distance value and the sample of the representation at the index location, to obtain a second distance value; and providing, as the geometry information, a signed distance value obtained by modifying the first distance value using the signed distance value. The use of signed distance values has been found to make superior learned geometry possible.

A second aspect of the invention relates to a method of training the neural network described above. This may be done by treating it as a generator neural network, and training it jointly with a discriminator neural network (i.e. with successive updates to the generator network being interleaved with, or simultaneous with, successive updates to the discriminator neural network). The discriminator neural network is updated to enhance its ability to distinguish between images produced by the generator neural network (fake images) and images from a training database. The images in the training database may be images captured by one or more corresponding cameras.

The invention may be expressed as a method, or alternatively as a system comprising one or more computers and one or more storage devices storing instructions that when executed by the one or more computers cause the one or more computers to perform the method. It may also be expressed as a computer program product, such as downloadable program instructions (software) or one or more non-transitory computer storage media storing instructions. When executed by one or more computers, the program instructions cause the one more computers to perform the method.

### BRIEF DESCRIPTION OF THE DRAWINGS

Embodiments of the invention will now be described for the sake of example only with reference to the following drawings, in which:

FIG. 1 is a diagram of an example generator neural network which is an embodiment of the invention;

FIG. 2 is a diagram of an example training system for training the generator neural network of FIG. 1;

FIG. 3 is a flow diagram of an example process for generating an image of a human;

FIG. 4 is a flow diagram of an example process for training the generator neural network of FIG. 1; and

FIG. 5 shows a computer system which can be used to perform the methods of FIGS. 4 and 5, and to implement the generator neural network of FIG. 1 and the training system of FIG. 2.

### DETAILED DESCRIPTION

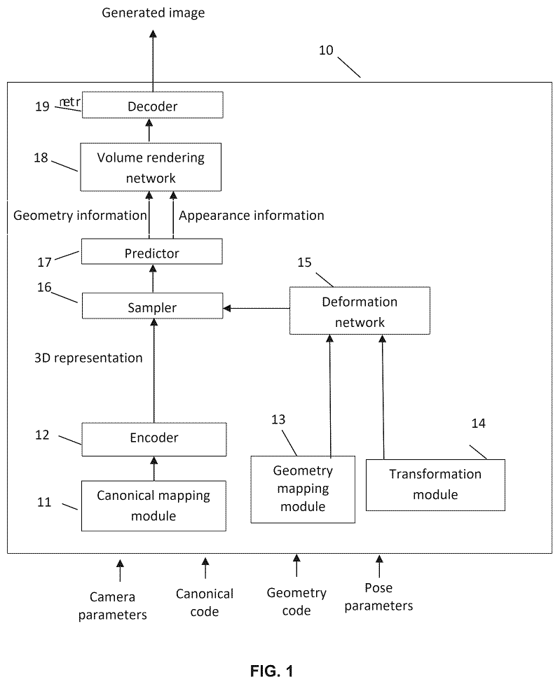

FIG. 1 shows an example generator neural network 10 for generating an image of a human. The generator neural network 10 may be suitable to generate images of clothed humans with various appearance styles and in arbitrary poses. The generator neural network 10 may also be suitable to generate images of animated human avatars.

The generator neural network 10 is configured to receive camera parameters describing a view angle. As explained below, the generator neural network 10 is configured such that the camera parameters control the view angle used in the rendering of the image of the human. In other words, the image generated by the generator neural network 10 depicts the human viewed from the view angle.

The generator neural network 10 is further configured to receive pose parameters describing a shape and a pose of a parametric human body model. When arranged according to the pose parameters, the parametric human body model represents a 3D human body model with a body shape according to the shape described by the pose parameters and in a body pose according to the pose described by the pose parameters. The shape described by the pose parameters may for example be indicative of a height and/or level of obesity (e.g. the body mass index) of the parametric human body model. The pose described by the pose parameters may control the way the parametric human body model stands and may be a natural human pose. An example parametric human body model, referred to as SPML model, is described in more detail in Matthew Loper, et al., “SMPL: a skinned multi-person linear model”, ACM Trans. On Graphics, 2015. The pose parameters may be parameters of the SPML model. That is, the pose parameters may be, or comprise, SPML parameters.

As explained below, the generator neural network 10 is further configured such that the pose parameters control the body shape and the body pose of the human depicted in the generated image. In other words, the image generated by the generator neural network 10 depicts the human in the pose described by the pose parameters.

The generator neural network 10 is further configured to receive a first array of random numbers, referred to as canonical code or first latent vector. Alternatively, the generator neural network 10 may be configured to generate the canonical code instead of receiving it, for example using a random number generator unit of the generator neural network 10.

The generator neural network 10 is further configured to receive a second array of random numbers, referred to as geometry code or second latent vector. Alternatively, the generator neural network 10 may be configured to generate the geometry code instead of receiving it, for example using the random number generator.

The generator neural network 10 includes a canonical mapping module 11 configured to receive the camera parameters and the canonical code, and to generate a first condition feature vector. The canonical mapping module may be implemented by using a multi-layer perceptron, such as an 8-layer multi-layer perceptron.

The generator neural network 10 further includes a geometry mapping module 13 configured to receive the pose parameters and the geometry code, and to generate a second condition feature vector. The geometry mapping module 13 may be implemented by using a further-layer perceptron, such as an 8-layer multi-layer perceptron.

The generator neural network 10 includes an encoder 12. The encoder is configured to receive the first condition feature vector and to generate a “3D representation”, which is a representation of a first 3D space (or “canonical space”) comprising a human in a predetermined pose (for example, a pose in which all limbs of the person are extended straight out from the torso of the person). That is, each spatial point in the space is associated with a set of features indicative of the human in the predetermined pose.

Any spatial point (“index location”) in the 3D space can be sampled using a sampler unit 16. The sampler unit 16 receives the index location, and samples the 3D representation to retrieve the set of feature data associated with the index location. The 3D representation may be an explicit representation, for example based on voxel grids. Alternatively, the 3D representation may be an implicit representation representing the first 3D space as a continuous function.

Preferably, the 3D representation is a hybrid explicit-implicit representation, such as tri-plane representation described in detail in Eric R. Chan, et al., “Efficient Geometry-aware 3D Generative Adversarial Networks” arxiv.org, arXiv:2112.07945, 2012.

In one example, the encoder 12 is configured to generate three feature planes as the 3D representation of the first 3D space. Each feature plane is a N×N×C array with N being the spatial resolution and C the number of channels. N may be 256 and C may be 32. The three feature planes can be thought of as being axis-aligned orthogonal planes. Feature data of arbitrary 3D points can be obtained via a look-up on the three planes. In other words, any 3D position in the first 3D space can be sampled by projecting it onto each of the three feature planes, retrieving the corresponding feature vector via bilinear interpolation, and aggregating the three features via summation.

To put this another way, the tri-plane representation is based on three feature planes spanned respectively by coordinates (x-y), (y-z) and (z-x). Each feature plane is an N×N array, and each pixel of each array is associated with a respective set of feature data (C feature values). Given an index location (x,y,z), the sampler 16 samples the triplane representation by: obtaining C feature values by interpolating between the C feature values for each the pixels neighbouring location (x,y) on the first plane; obtaining C feature values by interpolating between the C feature values for each the pixels neighbouring location (y,z) on the second plane; and obtaining C feature values by interpolating between the C feature values for each the pixels neighbouring location (z,x) on the third plane. The three sets of C features values are then aggregated.

Note that in an implementation, the encoder 12 and sampler unit 16 may be implemented as a single unit which receives the first condition vector and a dataset specifying the index location, and generates the set of feature data associated with the respective spatial point at the index location (i.e. without generating feature data for other points).

The generator neural network 10 includes a transformation module 14 configured to receive the camera parameters and the pose parameters. For each of a plurality of values of the integer index i, the transformation module 14 is configured to generate a first plurality of coordinates Pᵢ indicating the location of a corresponding spatial point in a first image of the parametric human body model arranged in the pose described by the pose parameters and viewed from the view angle described by the camera parameters. The space depicted by the first image is referred to as an “observation space”.

The transformation module 14 is further configured to apply a mapping transformation to the first plurality of coordinates Pᵢ corresponding to each spatial point, to generate a respective second plurality of coordinates Pᵢ′. The second plurality of coordinates corresponding to each spatial point indicate the location of a respective second spatial point in a second image of the parametric human body model in the predetermined pose. The mapping transformation is based on the pose described by the pose parameters and the predetermined pose. In other words, the mapping transformation maps the spatial points in the observation space to respective second spatial points in the canonical space.

In one example, the parametric human body model is the SPML model and the pose parameters are given by vector p=(θ, β) where θ and β are the SPML pose and shape parameters respectively. In this example, the first image depicts the SPML human body arranged according to vector p=(θ, β) and viewed from the view angle described by the camera parameters.

To map any point Pᵢ of first plurality of coordinates to a respective point Pᵢ′ in the canonical space, the SMPL model may be used to guide the transformation performed by the transformation module 14. SMPL defines a skinned vertex-based human model (V, W), where v E V is the vertex and w E W is the skinning weight assigned for the vertex such that Σⱼwⱼ=1, wⱼ≥0 for each joint. As such, the inverse-skinning transformation may be used to map the SMPL mesh in the observation space with the SPML pose θ into the canonical space with the predetermined pose:

$${T}_{SMPL} ( v , w , θ ) = {\sum }_{j} {w}_{j} ( {R}_{j} v + {t}_{j} ) ,$$

Where Rⱼ and tⱼ are the rotation and translation at each joint j derived from the SMPL model with SPML pose θ. The predetermined pose may be denoted can ϑ_{can}.

A person skilled in the art would understand that such formulation can be extended to any spatial point in the observation space by adopting the same transformation from the nearest point on the surface of the SMPL mesh. Formally, for each spatial point Pᵢ, the nearest point v* on the SMPL mesh surface is found as v*=arg min_{vϵV}(∥Pᵢ−v∥). Then the corresponding skinning weights w* are used to transform Pᵢ to Pᵢ′ in the canonical space as:

$${P}_{i}^{′} = {T}_{o} ( {P}_{i} \vert θ ) = {T}_{SMPL} ( v , {w}^{*} , θ ) .$$

The generator neural network 10 includes a deformation network 15 configured to receive from the transformation module 14 the spatial points Pᵢ′ in the canonical space and from geometry mapping module 13 the second condition feature vector. The deformation network 15 is further configured to process the spatial points Pᵢ′ and the second condition feature vector to generate a deformation ΔPᵢ of the spatial points Pᵢ′ in the canonical space. The deformation ΔPᵢ can be Expressed as

$$Δ {P}_{i} = {T}_{Δ} ( {P}_{i}^{′} \vert g , β ) ,$$

where g is the second condition feature vector. In one example, the deformation network 15 completes the fine-grained geometric transformation from the observation space to the canonical space, and compensates inaccuracies of the mapping transformation applied by the transformation module 14. In one example, the deformation network 15 compensates inaccuracies of the inverse-skinning transformation. In one example, the deformation network 15 provides pose-dependent deformations for improved modelling of non-rigid dynamics. In one example, the deformation ΔPᵢ provided by the deformation network 15 improves the quality with which cloth wrinkles are depicted in the final image. Note that in some embodiments, the geometry mapping module 13 and deformation network 15 could be omitted, which would mean there is no need for the geometry code. However, this would lead to less realistic generated images.

The transformation module 14 may be implemented using a further multi-layer perceptron. In this case, the spatial points Pᵢ′ are processed by yet another multi-layer perceptron to generate embedded spatial points Pᵢ′ which are then concatenated with the second condition feature vector g and the SMPL shape β, and fed into the further multi-layer perceptron:

$$Δ {P}_{i} = MLPs ( Concat ( Embed ( {P}_{i}^{′} ) , g , β ) .$$

In general terms, a combined purpose of the transformation module 14 and the deformation network 15 is to provide a final mapping transformation T_{o→c}(Pᵢ) from the observation space to the canonical space which can be expressed as:

$${T}_{o \to c} ( {P}_{i} ) = {P}_{i}^{′} + Δ {P}_{i} = ( {P}_{i} \vert θ ) + {T}_{Δ} ( {P}_{i}^{′} \vert g , β ) .$$

In other words, the deformation network 15 modifies the second plurality of coordinates generated by the transamination module 14. The modified second plurality of coordinates, comprising the mapped spatial point

$${P}_{i}^{′} + Δ {P}_{i} ,$$

are referred to as index locations. There is one index location for each value of i.

As noted, the generator neural network 10 includes the sampler unit 16 configured to sample the 3D representation at each of the index locations to receive feature data fⁱ (also called “features values”). The sampler unit transmits the sampled feature data fⁱ to a predictor module 17. The predictor module 17 is configured to generate geometry information and appearance information for each index location by processing the received feature data fⁱ.

The predictor module 17 may include a first multi-layer perceptron which is configured to process the sampled feature data for each index location to generate corresponding appearance information. The appearance information may describe a color associated with the respective index location. In an example where the number of channels of the feature planes comprised in the 3D representation is C, the appearance information, generated by the first multi-layer perceptron for each index location, is a vector comprising C values. For example, the number of channels of the feature planes may be 32, and the appearance information, generated by the first multi-layer perceptron for each index location, may be a vector comprising 32 values.

The predictor module 17 may include a second multi-layer perceptron which is configured to process the sampled feature data for each index location to generate corresponding geometry information. The geometry information may be a signed distance value or a density value associated with the respective index location.

In an example where the geometry information is a signed distance value, the predictor module 17 is further configured to generate a 3D mesh data of the parametric human model arranged in the predefined pose and with the shape described by the pose parameters. The mesh may be denoted M=SMPL (θ_{can},β). In this case, the predictor module 17 is also configured to sample the 3D mesh data of the parametric human model at each of the index locations

$${P}_{i}^{′} + Δ {P}_{i}$$

to obtain respective coarse signed distance values

$${d}_{can}^{i} .$$

The predictor module 17 is further configured to feed, for each index location, the feature data fⁱ sampled from the 3D representation concatenated with the respective coarse signed distance value

$${d}_{can}^{i}$$

into the second multi-layer perceptron to generate a residual signed distance value Δdⁱ. The predictor module 17 is further configured to provide, as the geometry information, a signed distance value dⁱ obtained by modifying the coarse signed distance value

$${d}_{can}^{i}$$

using the residual signed distance value Δdⁱ. For example,

$${d}^{i} = {d}_{can}^{i} + Δ {d}^{i} .$$

In this example, providing a signed distance value rather than a density value may introduce direct geometry regulation and guidance into the generator neural network 10.

The generator neural network 10 includes a volume rendering network 18 configured to process the geometry information and the appearance information to generate a feature image and a RGB image. The volume rendering network furthermore receives the pose parameters. Both the feature image and the RGB image depict the human viewed from the view angle described by the camera parameters and with the body of the human having the shape and the pose described by the pose parameters. In one example, the volume rendering network 18 is configured to convert the signed distance value dᵢ, provided as geometry information by the predictor module 17, of each point Pᵢ along a ray r to a density value σᵢ as

$${σ}_{i} = \frac{1}{α} Sigmoid ( \frac{{d}_{i}}{α} ) ,$$

where α>0 is a learnable parameter that controls the tightness of the density around the surface boundary. By integrating along the ray r the corresponding pixel feature is obtained as

$$I ( r ) = {\sum }_{i = 1}^{N} ( {\prod }_{j = 1}^{i - 1} {e}^{- {σ}_{i} {δ}_{i}} ) {c}_{i} ,$$

with δᵢ=∥Pᵢ−Pᵢ₋ᵢ∥, N is the number of spatial points in the observation space, and the cᵢ is a vector describing the appearance information obtained from the feature data fⁱ sampled from the 3D representation at the index location

$${T}_{o \to c} ( {P}_{i} ) = {P}_{i}^{′} + Δ {P}_{i} .$$

The volume rendering network 18 is further configured to integrate a plurality of rays to generate the feature image. The feature image may have a channel depth and resolution of 32×128×128. The RGB image may have a channel depth and resolution of 3×128×128.

The generator neural network 10 includes a decoder 19 configured to process the feature image and the RGB image to generate the image of the human. The decoder 19 may be further configured to also process the first condition feature vector generated by the canonical mapping module 11. In one example, the decoder 19 is configured to generate the image of the human with a resolution that is higher than the resolution of the RGB image. An example architecture of the decoder 19 is described in detail in Tero Karras, et al., “Analyzing and Improving the Image Quality of StyleGAN”, CVPR, 2020.

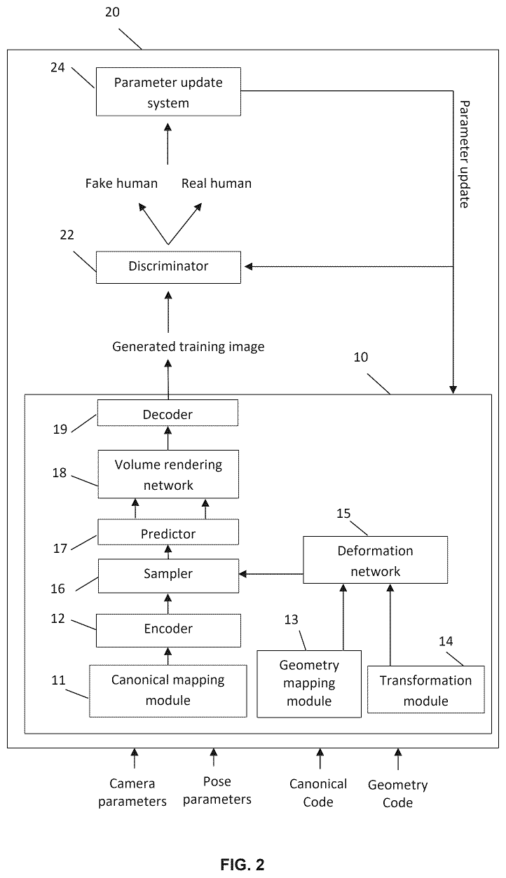

The generator neural network 10 may be trained as part of a generative adversarial network comprising the generator neural network 10 and a discriminator. FIG. 2 shows an example training system 20 for training the generator neural network 10. To avoid unnecessary repetition, like reference numerals will be used to denote like features.

The training system 20 comprises the generator neural network 10, a discriminator neural network 22 and a parameter update system 24. The generator neural network 10 is as described with reference to FIG. 1.

The training system 20 is configured to receive as inputs the camera parameters, the pose parameters, the canonical code, and the geometry code.

The discriminator neural network 22 is configured to receive a training image of a human generated by the generator neural network 10, and to generate a prediction of whether the training image of a human is an image of a real human or an image of a fake human (i.e. one generated by the generator neural network 22). In one example, the discriminator neural network 22 is configured to receive the image generated by the decoder 19 and the RGB image generated by the volume rendering network 18. In this example the consistency of generated multi-view images may be improved. Additionally or alternatively, the discriminator neural network 22 may be configured to also receive the camera and pose parameters. In this example, the images generated by the trained generator neural network may show an improved consistency with the camera and pose parameters.

The parameter update system 24 is configured to process the prediction generated by the discriminator neural network 22 and to modify one or more network parameters of the generator neural network 10 and the discriminator neural network 22 based on the prediction. By modifying the one or more network parameters, the parameter update system 24 trains i) the generator neural network 10 to generate photorealistic images of humans, and ii) the discriminator neural network 22 to reliably distinguish between images of real and fake humans. For example, the parameter update system 24 updates the discriminator neural network 22 when it fails to identify that a generated training image it receives from the generator neural network 10 is an image of a fake human, and updates the generator neural network 10 when the discriminator neural network 22 identifies that a generated training image it receives from the generator neural network 10 is an image of a fake human.

The discriminator neural network 22 may be further trained using a training dataset comprising labelled images of real humans. This process is carried out by updating steps which are interleaved with the updating described above. Specifically, the parameter update system 24 updates the discriminator neural network 22 when it fails to identify that a generated training image it receives from the training dataset is an image of a real human.

The parameter update system 24 may be configured to modify the one or more network parameters based on a non-saturating GAN loss L_{GAN} with R1 regularization L_{Reg}. In an example where the geometry information is provided as signed distance values, parameter update system 24 may be further configured to modify the one or more network parameters also based on an eikonal loss defined as:

$${L}_{Eik} = {\sum }_{{P}_{i}} {( ‖ ∇ d\_i ‖ - 1 )}^{2} .$$

Further in this example, the parameter update system 24 may be further configured to modify the one or more network parameters also based on minimal surface loss to encourage the generator neural network 10 to represent the human geometry with minimal volume of zero-crossings:

$${L}_{Minsurf} = {\sum }_{{P}_{i}} {e}^{( - 100 {d}_{i} )} .$$

Still further in this example, the parameter update system 24 may be further configured to modify the one or more network parameters also based on a loss L_{SMPL} such that the generated surface is close to the given SMPL mesh and consistent with the given SMPL pose. To this end, the vertices v E V are perturbed with random noise δᵥ on the SMPL mesh and the 3D representation is sampled at the respective points:

$${L}_{SMPL} = {\sum }_{v ∈ V} ‖ {MLP}_{d} ( F ( v + {δ}_{v} ) ) ‖ .$$

The overall loss, in this example, can be expressed as:

$${L}_{total} = {L}_{GAN} + {λ}_{Reg} {L}_{Reg} + {λ}_{Eik} {L}_{Eik} + {λ}_{Minsurf} {L}_{Minsurf} + {λ}_{SMPL} {L}_{SMPL} ,$$

where λ, are the corresponding loss weights.

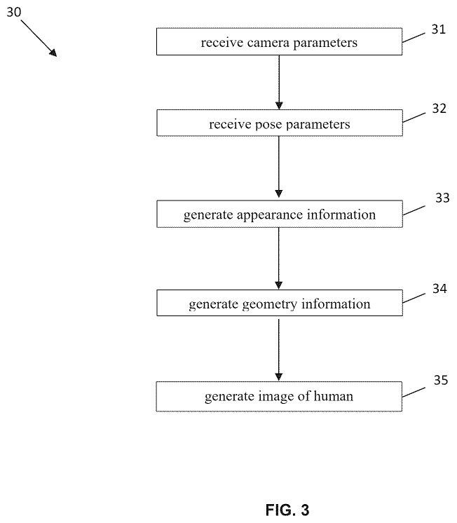

Referring to FIG. 3, a method 30 to generate the image of the human using the generator neural network 10, as described with reference to FIG. 1, is explained.

In step 31, the camera parameters describing the view angle are received. The camera parameters control the view angle used in the rendering of the image of the human. Also in step 31, the canonical code is either received or generated by the generator neural network 10. Further in step 31, the canonical mapping module receives the camera parameters and the canonical code, and generates the first condition feature vector.

In step 32, the pose parameters describing the shape and the pose of a parametric human body model are received. The pose parameters control the body shape and the body pose of the human depicted in the generated image. Also in step 32, the geometry code is either received or generated by the generator neural network 10. Further in step 32, the geometry mapping module receives the pose parameters and the geometry code, and generates the second condition feature vector.

In step 33, the camera parameters and the pose parameters are processed to generate appearance information. To this end, the encoder receives the first condition feature vector and generates the 3D representation of the first 3D space (or “canonical space”) comprising the human in the predetermined pose. In one example, the encoder 12 generates, in step 33, three feature planes as the 3D representation of the first 3D space.

Also in step 33, the transformation module 14 generates a first plurality of coordinates indicating N spatial points in the first image of the parametric human body model arranged in the pose described by the pose parameters and viewed from the view angle described by the camera parameters. The transformation module 14 further applies a mapping transformation to the first plurality of coordinates to generate a second plurality of coordinates indicating respective second spatial points in the second image of the parametric human body model in the predetermined pose, wherein the mapping transformation is based on the pose described by the pose parameters and the predetermined pose.

When the parametric human body model is the SPML model and the pose parameters are given by the vector p=(θ, β), the transformation module 14 applies the mapping transformation

$${P}_{i}^{′} = {T}_{o} ( {P}_{i} \vert θ ) = {T}_{SMPL} ( v , {w}^{*} , θ )$$

to map each spatial point Pᵢ of the first plurality of coordinates to a respective point

$${P}_{i}^{′}$$

of the second plurality of coordinates.

Further in step 33, the deformation network 15 processes the spatial points Pᵢ′ and the second condition feature vector to generate the deformation ΔPᵢ of the spatial points Pᵢ′ in the canonical space. Effectively, the transformation module 14 and the deformation network 15 map together the first plurality of coordinates in the observation space to the index locations in the canonical space according to the final mapping transformation

$${T}_{o \to c} ( {P}_{i} ) = {P}_{i}^{′} + Δ {P}_{i} .$$

Still in step 33, the predictor module 17 samples the 3D representation at each of the index locations to receive feature data fⁱ. Then the predictor module 17 generates appearance information by processing the received feature data. The predictor module 17 may include the first multi-layer perceptron which processes each set of sampled feature data fⁱ to generate the corresponding appearance information. The appearance information may describe a color associated with the respective index location.

In step 34, the predictor module 17 generates geometry information by processing the received feature data. The predictor module 17 may include the second multi-layer perceptron which processes each sampled feature data to generate corresponding geometry information. The geometry information may be a signed distance value. In this case, the predictor module 17 generates the 3D mesh data of the parametric human model arranged in the predefined pose and with the shape described by the pose parameters. Further in this case, the predictor module 17 then samples the 3D mesh data of the parametric human model at each of the index locations to obtain coarse signed distance values. The predictor module 17 feeds for each index location the feature data sampled from the 3D representation concatenated with the respective coarse signed distance value into the second multi-layer perceptron to generate a residual signed distance value. Then the predictor module 17 provides, as the geometry information, the signed distance value obtained by modifying the coarse signed distance value using the residual signed distance value.

In step 35, the volume rendering network 18 processes the geometry information, the appearance information, and the pose parameters, to generate the feature image and the RGB image. Both the feature image and the RGB image depict the human viewed from the view angle described by the camera parameters and with the body of the human having the shape and the pose described by the pose parameters.

Further in step 35, the decoder 19 processes the feature image and the RGB image to generate the image of the human. In one example, the decoder 19 generates the image of the human with a resolution that is higher than the resolution of the RGB image.

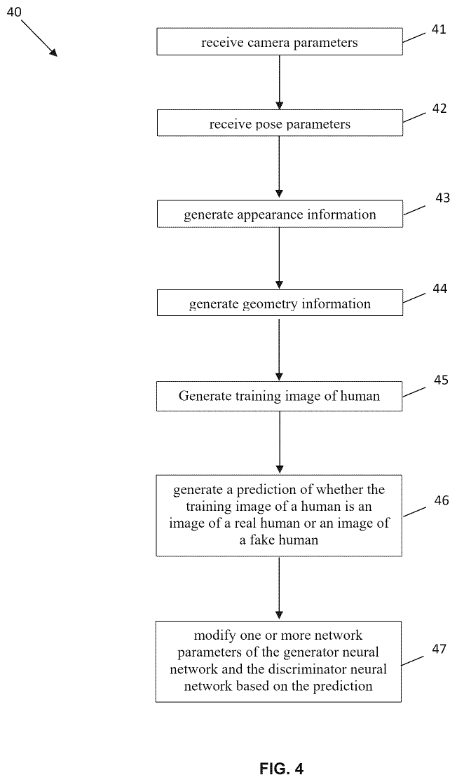

Referring to FIG. 4, a method 40 to train the generator neural network 10 and the discriminator neural network 22, as described with reference to FIG. 2, is explained. In general terms, a training image is generated by the generator neural network 10, and then classified by the discriminator neural network 22 as an image of a real human or an image of a fake human. Based on whether the classification is correct or false, the one or more network parameters of the generator neural network 10 or the discriminator neural network 22 are modified.

In step 41, similar to step 31 described with reference to FIG. 3, the camera parameters describing the view angle are received. The camera parameters control the view angle used in the rendering of the training image of the human. Also in step 41, the canonical code is either received or generated by the generator neural network 10. Further in step 41, the canonical mapping module receives the camera parameters and the canonical code, and generates the first condition feature vector.

In step 42, similar to step 32 described with reference to FIG. 3, the pose parameters describing the shape and the pose of a parametric human body model are received. The pose parameters control the body shape and the body pose of the human depicted in the generated training image. Also in step 42, the geometry code is either received or generated by the generator neural network 10. Further in step 42, the geometry mapping module receives the pose parameters and the geometry code, and generates the second condition feature vector.

In step 43, similar to step 33 described with reference to FIG. 3, the camera parameters and the pose parameters are processed to generate appearance information. To this end, the encoder receives the first condition feature vector and generates the 3D representation of the first 3D space (or “canonical space”) comprising the human in the predetermined pose. In one example, the encoder 12 generates, in step 43, three feature planes as the 3D representation of the first 3D space.

Also in step 43, the transformation module 14 generates a first plurality of coordinates indicating N spatial points in the first image of the parametric human body model arranged in the pose described by the pose parameters and viewed from the view angle described by the camera parameters. The transformation module 14 further applies a mapping transformation to the first plurality of coordinates to generate a second plurality of coordinates indicating respective second spatial points in the second image of the parametric human body model in the predetermined pose, wherein the mapping transformation is based on the pose described by the pose parameters and the predetermined pose.

When the parametric human body model is the SPML model and the pose parameters are given by the vector p=(θ, β), the transformation module 14 applies the mapping transformation

$${P}_{i}^{′} = {T}_{o} ( {P}_{i} \vert θ ) = {T}_{SMPL} ( v , {w}^{*} , θ )$$

to map each spatial point Pᵢ of the first plurality of coordinates to a respective point

$${P}_{i}^{′}$$

of the second plurality of coordinates.

Further in step 43, the deformation network 15 processes the spatial points Pᵢ′ and the second condition feature vector to generate the deformation ΔPᵢ of the spatial points Pᵢ′ in the canonical space. Effectively, the transformation module 14 and the deformation network 15 map together the first plurality of coordinates in the observation space to the index locations in the canonical space according to the final mapping transformation

$${T}_{o \to c} ( {P}_{i} ) = {P}_{i}^{′} + Δ {P}_{i} .$$

Still in step 43, the predictor module 17 samples the 3D representation at each of the index locations to receive feature data fⁱ. Then the predictor module 17 generates appearance information by processing the received feature data. The predictor module 17 may include the first multi-layer perceptron which processes each set of sampled feature data fⁱ to generate the corresponding appearance information. The appearance information may describe a color associated with the respective index location.

In step 44, similar to step 34 described with reference to FIG. 3, the predictor module 17 generates geometry information by processing the received feature data. The predictor module 17 may include the second multi-layer perceptron which processes each sampled feature data to generate corresponding geometry information. The geometry information may be a signed distance value. In this case, the predictor module 17 generates the 3D mesh data of the parametric human model arranged in the predefined pose and with the shape described by the pose parameters. Further in this case, the predictor module 17 then samples the 3D mesh data of the parametric human model at each of the index locations to obtain coarse signed distance values. The predictor module 17 feeds for each index location the feature data sampled from the 3D representation concatenated with the respective coarse signed distance value into the second multi-layer perceptron to generate a residual signed distance value. Then the predictor module 17 provides, as the geometry information, the signed distance value obtained by modifying the coarse signed distance value using the residual signed distance value.

In step 45, similar to step 35 described with reference to FIG. 3, the volume rendering network 18 processes the geometry information, the appearance information, and the pose parameters, to generate the feature image and the RGB image. Both the feature image and the RGB image depict the human viewed from the view angle described by the camera parameters and with the body of the human having the shape and the pose described by the pose parameters.

Further in step 45, the decoder 19 processes the feature image and the RGB image to generate the training image of the human. In one example, the decoder 19 generates the training image of the human with a resolution that is higher than the resolution of the RGB image.

In step 46, the discriminator neural network 22 receives the training image of a human generated by the generator neural network 10, and generates the prediction of whether the training image of a human is an image of a real human or an image of a fake human (i.e. one generated by the generator neural network 22). In one example, the discriminator neural network 22 receives the image generated by the decoder 19 and the RGB image generated by the volume rendering network 18. In this example the consistency of generated multi-view images may be improved. Additionally or alternatively, the discriminator neural network 22 may also receive the camera and pose parameters. In this example, the images generated by the trained generator neural network may show an improved consistency with the camera and pose parameters.

In step 47, the parameter update system 24 processes the prediction generated by the discriminator neural network 22 and modifies the one or more network parameters of the generator neural network 10 and the discriminator neural network 22 based on the prediction. By modifying the one or more network parameters, the parameter update system 24 trains i) the generator neural network 10 to generate photorealistic images of humans, and ii) the discriminator neural network 22 to reliably distinguish between images of real and fake humans. For example, the parameter update system 24 updates the discriminator neural network 22 when it fails to identify that a generated training image it receives from the generator neural network 10 is an image of a fake human, and updates the generator neural network 10 when the discriminator neural network 22 identifies that a generated training image it receives from the generator neural network 10 is an image of a fake human.

The parameter update system 24 may modify the one or more network parameters based on a non-saturating GAN loss L_{GAN} with R1 regularization L_{Reg}. In an example where the geometry information is provided as signed distance values, parameter update system 24 may further modify the one or more network parameters also based on the eikonal loss. Further in this example, the parameter update system 24 may further modify the one or more network parameters also based on minimal surface loss to encourage the generator neural network 10 to represent the human geometry with minimal volume of zero-crossings. Still further in this example, the parameter update system 24 may further modify the one or more network parameters also based on the loss L_{SMPL} such that the generated surface is close to the given SMPL mesh and consistent with the given SMPL pose. The overall loss, in this example, may be Lₜₒₜₐₗ as expressed above.

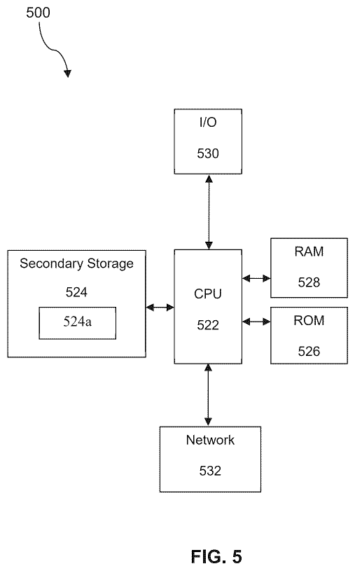

FIG. 5 is a block diagram showing the technical architecture 500 of a server which can perform some or all of a method according to FIG. 3 or FIG. 4. The technical architecture includes a processor 522 (which may be referred to as a central processor unit or CPU) that is in communication with memory devices including secondary storage 524 (such as disk drives), read only memory (ROM) 526, random access memory (RAM) 528. The processor 522 may be implemented as one or more CPU chips. The technical architecture may further comprise input/output (I/O) devices 530, and network connectivity devices 532.

The secondary storage 524 is typically comprised of one or more disk drives or tape drives and is used for non-volatile storage of data and as an over-flow data storage device if RAM 528 is not large enough to hold all working data. Secondary storage 524 may be used to store programs which are loaded into RAM 528 when such programs are selected for execution.

In this embodiment, the secondary storage 524 has an order processing component 524a comprising non-transitory instructions operative by the processor 522 to perform various operations of the method of the present disclosure. The ROM 526 is used to store instructions and perhaps data which are read during program execution. The secondary storage 524, the RAM 528, and/or the ROM 526 may be referred to in some contexts as computer readable storage media and/or non-transitory computer readable media.

I/O devices 530 may include printers, video monitors, liquid crystal displays (LCDs), plasma displays, touch screen displays, keyboards, keypads, switches, dials, mice, track balls, voice recognizers, card readers, paper tape readers, or other well-known input devices.

The processor 522 executes instructions, codes, computer programs, scripts which it accesses from hard disk, floppy disk, optical disk (these various disk based systems may all be considered secondary storage 524), flash drive, ROM 526, RAM 528, or the network connectivity devices 532. While only one processor 522 is shown, multiple processors may be present. Thus, while instructions may be discussed as executed by a processor, the instructions may be executed simultaneously, serially, or otherwise executed by one or multiple processors.

Although the technical architecture is described with reference to a computer, it should be appreciated that the technical architecture may be formed by two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the technical architecture 500 to provide the functionality of a number of servers that is not directly bound to the number of computers in the technical architecture 500. In an embodiment, the functionality disclosed above may be provided by executing the application and/or applications in a cloud computing environment. Cloud computing may comprise providing computing services via a network connection using dynamically scalable computing resources. A cloud computing environment may be established by an enterprise and/or may be hired on an as-needed basis from a third party provider.

By programming and/or loading executable instructions onto the technical architecture, at least one of the CPU 522, the RAM 528, and the ROM 526 are changed, transforming the technical architecture in part into a specific purpose machine or apparatus having the novel functionality taught by the present disclosure. It is fundamental to the electrical engineering and software engineering arts that functionality that can be implemented by loading executable software into a computer can be converted to a hardware implementation by well-known design rules.

Whilst the foregoing description has described exemplary embodiments, it will be understood by those skilled in the art that many variations of the embodiment can be made within the scope and spirit of the present invention.

1. A method for generating an image of a human using a neural network, the method comprising:
receiving camera parameters describing a view angle;
receiving pose parameters describing a shape and a pose of a parametric human body model;
processing the camera parameters and the pose parameters to generate geometry information and appearance information, and
processing the geometry information and the appearance information to generate the image of the human, the image depicting the human viewed from the view angle and with the body of the human having the shape and the pose described by the pose parameters.

2. The method of claim 1, wherein processing the camera parameters and the pose parameters to generate geometry information and appearance information includes:
processing the camera parameters to generate a representation of a first 3D space comprising a human in a predetermined pose;
obtaining one or more index locations based on the camera parameters and the pose parameters;
generating the geometry information and the appearance information from the representation by sampling the representation at the one or more index locations.

3. The method of claim 2, wherein processing the camera parameters to generate a representation of a first 3D space comprising a human in a predetermined pose, comprises:
receiving a first latent vector comprising random numbers;
transforming the camera parameters and the first latent vector into a first condition feature vector, and
processing the first condition feature vector to generate the representation of the first 3D space comprising the human in the predetermined pose.

4. The method of claim 2, wherein the representation of the first 3D space comprising the human in the predetermined pose includes 3 feature planes configured to provide feature data associated with points in the first 3D space.

5. The method of claim 2, wherein obtaining the one or more index locations comprises, for each index location:
processing the pose parameters and the camera parameters to generate a first plurality of coordinates indicating the location of a corresponding first spatial point in a first image of the parametric human body model arranged in the pose described by the pose parameters,
applying a mapping transformation to the first plurality of coordinates to generate a second plurality of coordinates indicating the location of a respective second spatial point in a second image of the parametric human body model in the predetermined pose, wherein the mapping transformation is based on the pose described by the pose parameters and the predetermined pose; and
obtaining the one or more index locations based on the corresponding second plurality of coordinates.

6. The method of claim 5, wherein obtaining the one or more index locations comprises processing the second coordinates and the pose parameters by a deformation network module.

7. The method of claim 2, wherein processing the camera parameters and the pose parameters to generate geometry information and appearance information, further includes:
processing, by a multi-layer perceptron, feature data obtained by sampling the representation at the one or more index locations, to generate the appearance information.

8. The method of claim 2, wherein processing the camera parameters and the pose parameters to generate geometry information and appearance information, further includes,
generating 3D mesh data of the parametric human model arranged in the predefined pose and with the shape described by the pose parameters;
sampling the 3D mesh data of the parametric human model at the one or more index locations to obtain a first distance value;
using the first distance value and the sample of the representation at the one or more index locations, to obtain a second distance value; and
providing, as the geometry information, a signed distance value obtained by modifying the first distance value using the signed distance value.

9. The method of claim 1, wherein processing the geometry information and the appearance information to generate the image of a human includes:
processing, by a volume rendering module of the neural network, the geometry information and the appearance information to generate a feature image and a RGB image, and
processing, by a decoder module of the neural network, the feature image and the RGB image to generate the image of the human.

10. The method of claim 9, wherein a resolution of the image of the human is higher than a resolution of the RGB image.

11. The method of claim 1, wherein the pose parameters include Skinned Multi-Person Linear model parameters.

12. The method of claim 1, wherein the geometry information characterizes a 3D geometry of the human, and the appearance information characterizes a RGB appearance of the human.

13. A method of training the neural network, the method comprising:
(a) generating a training image of a human by
providing camera parameters describing a view angle;
providing pose parameters describing a shape and a pose of a parametric human body model;
processing the camera parameters and the pose parameters by a generator neural network, configured to:
(i) generate geometry information and appearance information, and
(ii) process the geometry information and the appearance information to generate the training image of the human, the training image depicting the human viewed from the view angle and having the shape and the pose described by the pose parameters;
(b) processing of the training image of the human, by a discriminator neural network module to generate a prediction of whether the training image of a human is an image of a real human or an image of a fake human, and
(c) modifying one or more network parameters of the generator neural network and the discriminator neural network based on the prediction.

14. The method of claim 13, wherein (i) generate geometry information and appearance information includes:
processing the camera parameters to generate a representation of a first 3D space comprising a human in a predetermined pose;
obtaining one or more index locations based on the camera parameter and the pose parameters;
generating the geometry information and the appearance information from the representation by sampling the representation at the one or more index locations.

15. The method of claim 14, wherein processing the camera parameters to generate a representation of a first 3D space comprising a human in a predetermined pose, comprises:
receiving a first latent vector comprising random numbers;
transforming the camera parameters and the first latent vector into a first condition feature vector, and
processing the first condition feature vector to generate the representation of the first 3D space comprising the human in the predetermined pose.

16. The method of claim 14, wherein the representation of the first 3D space comprising the human in the predetermined pose includes 3 feature planes configured to provide feature data associated with points in the first 3D space.

17. The method of claim 14, wherein obtaining the one or more index locations comprises, for each index location:
processing the pose parameters and the camera parameters to generate a first plurality of coordinates indicating the location of a corresponding first spatial point in a first image of the parametric human body model arranged in the pose described by the pose parameters,
applying a mapping transformation to the first plurality of coordinates to generate a second plurality of coordinates indicating the location of a respective second spatial points in a second image of the parametric human body model in the predetermined pose, wherein the mapping transformation is based on the pose described by the pose parameters and the predetermined pose; and
obtaining the one or more index locations based on the second plurality of coordinates.

18. The method of claim 17, wherein obtaining the one or more index locations comprises processing the second coordinates and the pose parameters by a deformation network module.

19. The method of claim 14, wherein processing the camera parameters and the pose parameters to generate geometry information and appearance information, further includes:
processing, by a multi-layer perceptron, feature data obtained by sampling the representation at the one or more index locations, to generate the appearance information.

20-24. (canceled)

25. A system comprising one or more processors and one or more storage devices storing instructions that when executed by the one or more computers cause the one or more computers to perform operations comprising:
receiving camera parameters describing a view angle;
receiving pose parameters describing a shape and a pose of a parametric human body model;
processing the camera parameters and the pose parameters to generate geometry information and appearance information, and
processing the geometry information and the appearance information to generate the image of the human, the image depicting the human viewed from the view angle and with the body of the human having the shape and the pose described by the pose parameters.

26. (canceled)
